(19) United States
(12) Patent Application Publication
(10) Pub. No.: US 2010/0138411 A1
(43) Pub. Date: Jun. 3, 2010

(54) Segmented Query Word Spotting

(75) Inventors: SCOTT A. JUDY, NEWNAN, GA (US); MARSAL GAVALDA, SANDY SPRINGS, GA (US)

Correspondence Address: OCCHIUTI ROHLICEK & TSAO, LLP, 10 FAWCETT STREET, CAMBRIDGE, MA, 02138, US

(73) Assignee: NEXIDIA INC., ATLANTA, GA (US)

(21) Appl. No.: 12/623,550

(22) Filed: Nov. 23, 2009

Related U.S. Application Data
(60) Provisional application No. 61/118,641, filed on Nov. 30, 2008.

(51) Int. Cl. G06F 17/30

(52) U.S. Cl. 707/723; 707/769; 707/E17.109; 707/E17.009

(57) ABSTRACT

An approach to words spotting processes a query including a sequence of terms (e.g., words) to identify one or more subsequences that constitute segments (e.g., phrases) that are likely to occur spoken together in the audio begin searched. The segments are searched for as units. An advantage can include improved accuracy as compared to searching for the terms individually.

### CROSS-REFERENCE TO RELATED APPLICATIONS

This application claims the benefit of U.S. Provisional Application No. 61/118,641 filed Nov. 30, 2008, the content of which is incorporated herein by reference.

### BACKGROUND

This description relates to word spotting using segmented queries.

A word spotter can be used to locate specified words or phrases in media with an audio component, for example, in multimedia files with audio. In some systems, a query is specified that include multiple words or phrases. These words or phrases are searched for separately and scores for occurrences of detections of those words and phases are combined. However, it can be difficult to locate certain words, for example, because they are not articulated clearly in the input audio or the recording is of poor quality. This can be particularly true of certain words, such as short words. Longer words and phrases are generally better detected, at least in part because they are not as easily confused with other word sequences in the audio.

In some applications, a user specifies a query of a sequence of terms (e.g., words) that are to be search for in a set of units of media with audio components. For example, a user may desire to identify which telephone call or calls in a repository of monitored telephone calls match the query by including all the words in the query.

### SUMMARY

In one aspect, in general, an approach to word spotting processes a query including a sequence of terms (e.g., words) to identify one or more subsequences that constitute segments (e.g., phrases) that are likely to occur spoken together in the audio being searched.

In general, in one aspect, the invention features a computer-implemented method of searching a media file that includes accepting a query comprising a sequence of terms; identifying a set of one or more segments in the query comprising a sequence of two or more terms; and searching the media for the occurrences of a segment in the set of segments.

Embodiments of the invention may include one or more of the following features.

The segment may include a subsequence of the sequence of terms. The segment may include all of the terms in the query. Accepting a query may include receiving a sequence of terms in a text representation.

Searching the media may include forming a phonetic representation of each segment in the set of segments; evaluating a score at successive times in the media representative of a certainty that the media matches the phonetic representation of each segment at the successive times; and identifying putative occurrences of the segments according to the evaluated scores.

The method may further include forming a query score according to scores associated with each of the segments in the set of segments of the query.

Other general aspects include other combinations of the aspects and features described above and other aspects and features expressed as methods, apparatus, systems, computer program products, and in other ways.

Advantages can include one or more of the following.

By identifying segments in the query, and searching for the segments as being spoken together, performance may be improved as compared to searching for the individual terms. This improved performance may arise from one or more factors, including avoiding some terms in the segment from being missed completely, for example, as a result of having too low a score to be retained as a potential detection during a processing of the audio. Another factor that may improve performance arises from the option of using a phonetic representation of the segment as a whole in a manner than represents inter-word effects, such as coarticulation of the words.

Other features and advantages of the invention are apparent from the following description, and from the claims.

### DESCRIPTION OF DRAWINGS

FIGS. 1-3 are block diagrams of a segmented query word spotter system.

FIG. 4 is a graph indicating scores for queries in an audio signal.

FIG. 5 is an example of a query divided into segments.

### DESCRIPTION

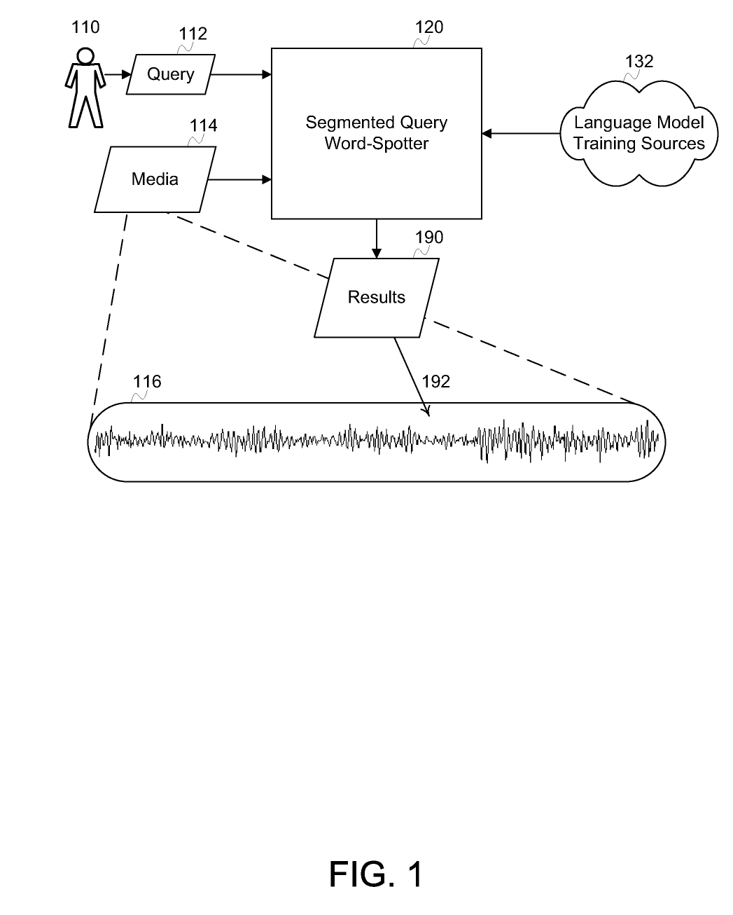

Referring to FIG. 1, a user 110 of a word spotting system uses the system to search for locations in media (e.g., an audio file or a multimedia file with audio content) 114 where speech represented in the media 114 matches a particular query 112. For example, the user creates a query 112 (e.g., as a sequence of terms such as words) and submits it to a segmented query word spotter 120. Generally, the segmented query word spotter makes use of language and/or domain specific information to identify segments or other constituents present in the query and searches for the identified elements in the media. In some examples, the query represents a set of words and phrases that are to be located together (e.g., in a same chapter or unit of the media 114, or within time proximity to each other or to a unit), and the identified segments or constituents are preferably found spoken together in the media, for example, as consecutive words of a phase. In some examples, the query is used to rank or distinguish between multiple media files, e.g., based on which files contain the query or portions of the query.

In some embodiments, the segmented query word spotter 120 identifies query segments, such as cohesive sequences of terms within the query (e.g., phrases), relying in part on language model training sources 132. The segmented query word spotter 120 then searches the media 114 for the query segments, or the individual query terms (e.g., words), or both. The segmented query word spotter 120 analyzes the search findings and determines probable locations in the media matching the query (results 190), for example, as time location 192 within the media's audio track 116, or as identifiers of units of the media (e.g., chapters or blocks of time) where the segments and/or individual terms of the query all occur. For each result, the word spotter computes a score related to the probability that the result correctly matches the query.

In some embodiments, a query is provided by the user as a sequence of terms, without necessarily providing indication of groupings of consecutive terms that may be treated as segments. A query may lack indication of groupings because, as examples, the query may have been input directly as text (without grouping indications such as quote marks or parentheses), generated by a speech to text system, or gleaned from either the media or a context of the media (e.g., text of a webpage from a website hosting the media). The segmented query words spotter 120 relies on models derived from language model training sources 132 to aid in detecting likely query segments even in the absence of clear grouping indicators. The word spotter 120 forms the query segments as groupings of query terms.

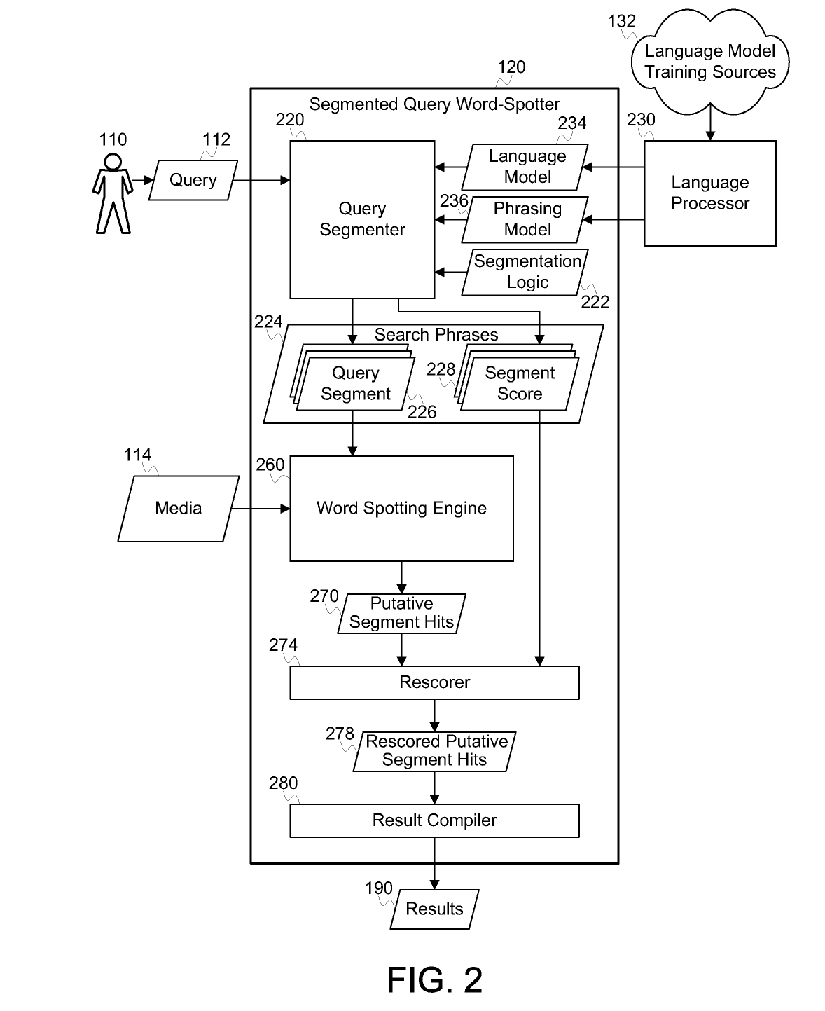

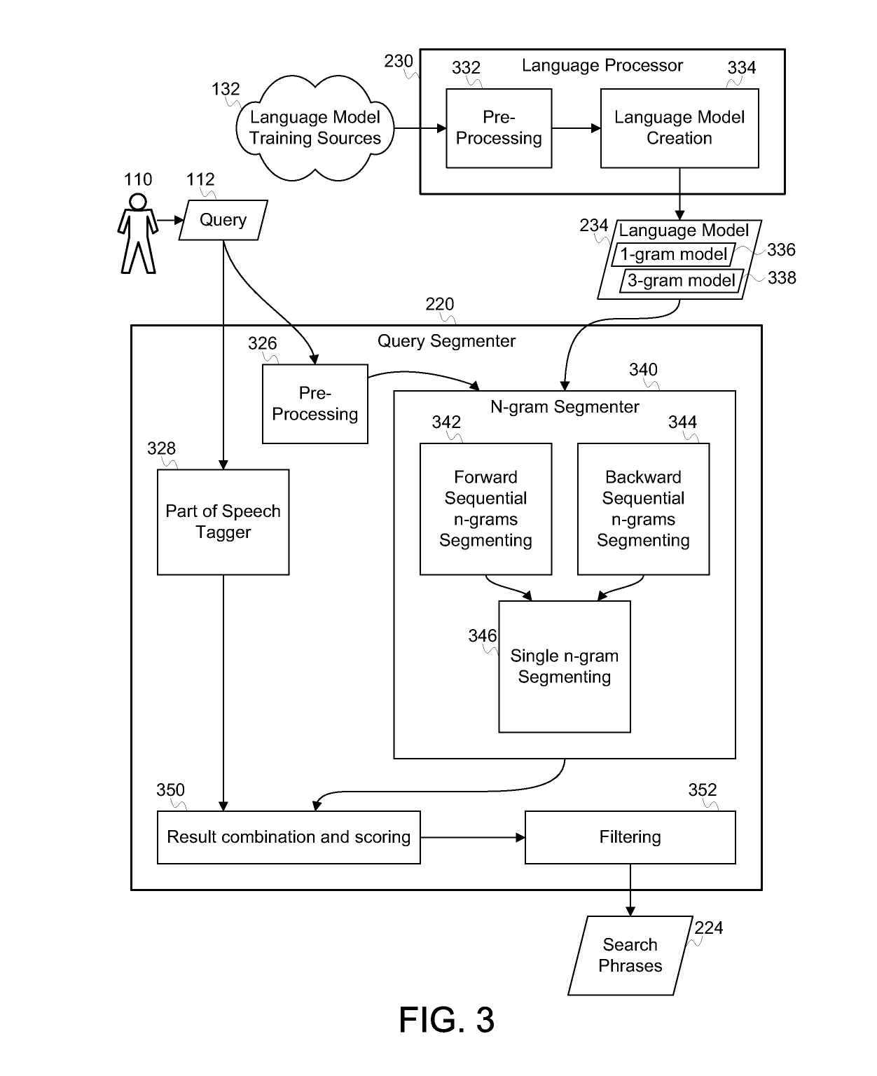

Referring to FIG. 2, the segmented query word spotter 120 includes a query segmenter 220, which determines how to break up the query into segments or how to combine individual query terms into segments. The query segmenter 220 processes the user provided query 112 into a segmented query 224. The segmented query 224 has one or more query segments 226. Each query segment 226 has a segment score 228 reflecting the probability of correctness of the segment, that is, how likely the component terms are actually meant by the user 110 to be grouped together as a segment. In some embodiments, the segments are disjoint portions of the string. In other embodiments, overlapping segments are permitted. In some embodiments, a segment may encompass the entire query. Operation of the query segmenter is shown in FIG. 3 and discussed in more detail below.

Continuing to refer to FIG. 2, after the query segments 226 are formed, a word spotting engine 260 forms phonetic representations of the segments and scans the media 114 for each segment 226 producing putative segment hits 270. Each segment hit is associated with a query segment, a location in the media (e.g., a time), and a score reflecting the probability that the location in the media corresponds to an audible instance of the query segment. In some embodiments, the word spotting engine uses an approach described in U.S. Pat. No. 7,263,484, “Phonetic Searching,” which is incorporated herein by references.

In some embodiments, after the word spotting engine 260 determines the putative segment hits 270, the scores of putative hits are combined with the individual segment scores 228 by a rescorer 274, which produces rescored putative segment hits 278. The rescorer 274 modifies the scores for the putative segment hits 270 to account for the probability that each segment is itself valid. For example, in some embodiments, the segment scores 228 are used to weight the scores associated with the putative hits 270.

In some embodiments, a result compiler 280 compiles the rescored putative segment hits 278 and determines results 190 for the overall query 112. For example, if the results are sections of a media file, than the best results are sections containing all, or most of, the query segments. In another example, if the results are distinct time locations in the file, then each segment hit is a result. The results 190 are then returned.

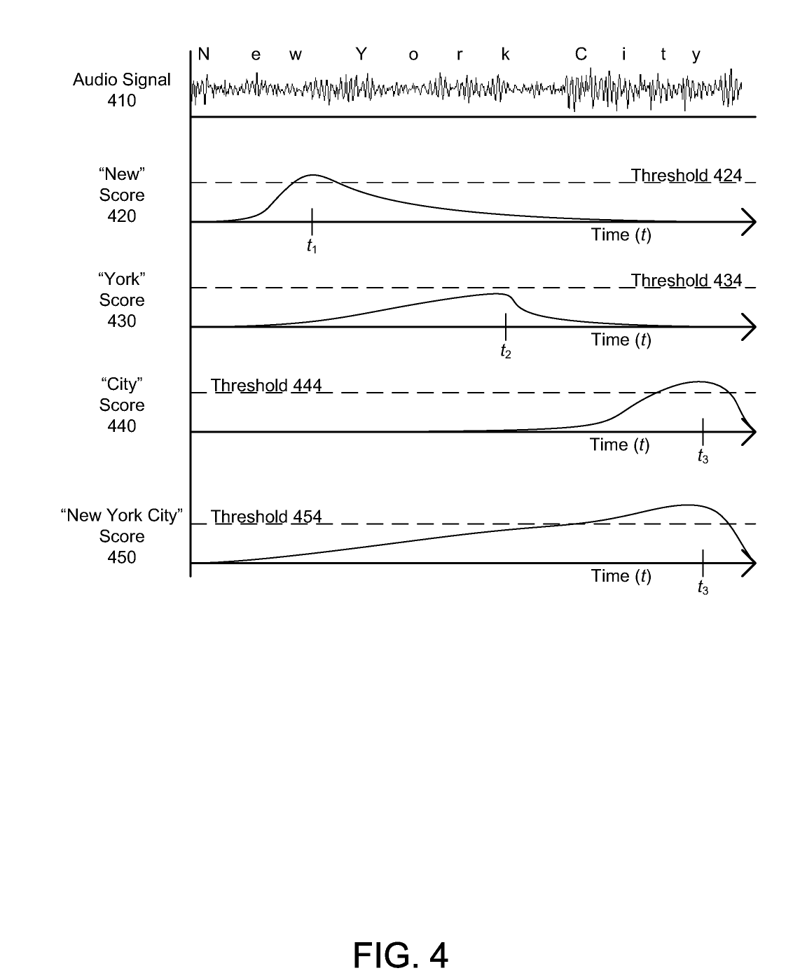

Referring to FIG. 4, an example query that includes the word sequence “New York City” may be processed without segmentation by individually searching for the words “New,” “York,” and “City.” A detection of the query then requires detection of each of the three words and, in some examples, requiring the correct order and time proximity. In searching for each of these words, the word spotting engine computes a score at successive discrete times in the media (e.g., every 10 ms.) and identifies putative hits for the words when the score crosses a threshold. For example, searching for “New” the score 420 increases as a likely hit for “New” occurs in the audio at time t₁ because the score 420 crosses the threshold 424 at that time.

Occasionally, an instance in the media that should match the query is soft or garbled in the audio signal and difficult to match. For example, the “k” sound in “York” is sometimes dropped or softened. A score for “York” 430 may never cross threshold 434 even at a valid location shown as t₂. Thresholds can be lowered to account for this, but at the cost of additional false-hits.

In embodiments of the system in which “New York City” is recognized by the segmented query word spotter as a segment, the word spotting engine searches for the segment as a whole. That is, the word spotter forms a phonetic representation and searches for the entire segment rather than its component elements. In some cases, a larger sample size increases the probability that the score 450 will cross the threshold 454. Thus, the score 450 indicating a hit for “New York City” at time t₃ may be more reliable than separately scoring hits for “New” 420, “York” 430, and “City” 440.

Referring again to FIG. 2, the query segmenter 220 operates on segmentation logic 222 and segmentation models (e.g., a language model 234 and/or a phrasing model 236). The segmentation logic 222 and the segmentation models drive analysis of the query for producing query segments. Models may be used independently or collectively, as controlled by the segmentation logic 222.

In some embodiments, the segmentation models include a language model 234 generated by the language processor 230 from language model training sources 132. In some examples, the language model 234 represents a statistical analysis of the language. This is discussed in more detail below. In some embodiments, a phrasing model 236 is used. In some examples, the phrasing model 236 is generated by the language processor 230 from language model training sources 132. In some examples, the phrasing model 236 is generated manually by experts in the language.

In some embodiments, the phrase model 236 includes lists of known phrases or known phrase patterns. For example, common place-names (“New York City”, “Los Angeles”, and “United States of America”) are known phrases. Additionally, in some embodiments, common phrase structures (e.g., “University of ______”) are also used for phrase recognition. Query terms are recognized by the query segmenter 220 as forming a known phrase when the terms match a known phrase or phrase pattern.

In some embodiments, a more generalized syntax-based or semantics-based model is used. An example of such a model relies on the use of a part-of-speech tagger to parse the query 112 into language components (terms) and identify linguistic roles (articles, determiners, adjectives, nouns, verbs, etc.) for each term. Adjacent terms that form common grammatical phrase structures (e.g., an adjective followed by a noun) are selected by the query segmenter 220 as potential segments. Probabilities that particular terms fall into a semantically correct phrase, as determined by the model, are used to assist in determining a segment score.

Referring to FIG. 3, in some embodiments, the query segmenter 220 uses a language model 234 generated by the language processor 230 from language model training sources 132. The language model 234 makes use of statistical information obtained from the training data 132 to identifying segments.

One statistical approach makes use of “n-gram” statistics in the training data. Using “n-gram” statistics, the probability of a particular term following or preceding a sequence of one or more terms is represented as either p(subsequent-term|precedent-sequence) or, respectively, p(precedent-term|subsequent-sequence). For example, in a sequence “a b c d e”, a comparison of p(d|bc) with p(d) may indicate that a phrase should end at c (before the d) if the quantity is less than 1.0. For example, such a ratio can be calculated as follows:

$$\frac{p ( d \vert bc )}{p ( d )} = \frac{p ( bcd )}{p ( bc ) \cdot p ( d )}$$

Similar processing can be done in the reverse direction as well. For example, a phrase that should start at c (after b) may be indicated by:

$$\frac{p ( b \vert c d )}{p ( b )}$$

Another statistical method is the comparison of successive n-grams. Based on the forward-moving comparison p(c|a b)>>p(d|b c), there may be a phrase boundary between c and d. Likewise, the backward comparison p(d|e f)>>p(c|d e) may indicate a phrase boundary between c and d even if the forward comparison did not.

These statistical methods may be applied in parallel.

Both of these statistically-based tests employ a threshold μₖ on the ratio between two probabilities. These thresholds may be determined heuristically, or they may be learned automatically from a pre-segmented corpus of text.

Referring to FIG. 3, the query segmenter 220 uses several methods of segmenting analysis and combines the results from each method to determine search phrases 224. These methods use language models 234 derived from training sources 132 by a language processor 230. The language processor 230 pre-processes (332) the training sources and creates (334) language model 234, for example, as smoothed 1-gram model 336 and smoothed 3-gram model 338.

The query segmenter 220 pre-processes (326) the query 112 and uses an n-gram segmenter 340 to determine segments. For example, the n-gram segmenter 340 locates probable break points in the query and divides the query accordingly. Probable break points are determined using a forward analysis 342 and a backward analysis 344. A secondary method 346 that further divides segments if the forward analysis and backward analysis did not find adjacent breaks. The results are then combined and scored (350). The query 112 may also be analyzed by a part of speech tagger 328. The results of the part of speech tagger analysis are included in the combining and scoring (350). The combined and scored segments are filtered (352) and returned as search phrases 224. Filtering is explained in more detail below. The phrases most likely to occur within the language, according to the analysis derived from the language model training sources 132, are used as search phrases 224.

Sequential n-grams analysis compares probabilities of individual terms either following or preceding sequences of other terms. Breaks are determined where the probabilities fall below a threshold μ. For example, a forward sequential 3-grams analysis 342 examines the probability of a fourth term following a sequence of second and third terms with the probability of the third term following a sequence of first and second terms:

$$\frac{P 〈 {w}_{i + 1} \vert {w}_{i - 1} {w}_{i} 〉}{P 〈 {w}_{i} \vert {w}_{i - 2} {w}_{i - 1} 〉} < {μ}_{2} and P ( {w}_{i} ) > {μ}_{1}$$

Likewise, a reverse sequential 3-grams analysis 344 examines the probability of an term preceding a sequence:

$$\frac{P 〈 {w}_{i} \vert {w}_{i + 1} {w}_{i + 2} 〉}{P 〈 {w}_{i + 1} \vert {w}_{i + 2} {w}_{i + 3} 〉} < {μ}_{2} and P ( {w}_{i + 1} ) > {μ}_{1}$$

2-grams analysis is used at text boundaries.

Segmentation based on single n-gram analysis 346 considers a break between wₙ and wₙ₊₁ in a series w₁ . . . wᵢ₋₁ wᵢ wᵢ₊₁ . . . wₙ:

$$IF \frac{P ( {w}_{i - 1} {w}_{i} {w}_{i + 1} )}{P ( {w}_{i - 1} {w}_{i} ) P ( {w}_{i + 1} )} < {μ}_{3} \\ simplify \to \frac{P 〈 {w}_{i + 1} \vert {w}_{i - 1} {w}_{i} 〉}{P ( {w}_{i + 1} )} < {μ}_{4} ( 3 \text{-} gram ) \qquad$$

AND no backward breaks on wₙ₋₁, wₙ

AND no forward breaks on wₙ₊₁, wₙ₋₂

At text boundaries, or if data is too sparse for a 3-gram, fall back to:

$$\frac{P ( {w}_{i} {w}_{i + 1} )}{P ( {w}_{i} ) P ( {w}_{i + 1} )} < {μ}_{3}$$

$$simplify \to \frac{P 〈 {w}_{i + 1} \vert {w}_{i} )}{P ( {w}_{i + 1} )} < {μ}_{4} ( 2 \text{-} gram )$$

Note that segmentation based on single n-gram analysis 346 incorporates forward sequential 3-grams analysis 342 and backward sequential 3-grams analysis 344. Each statistical approach relies on a language model 234 derived by a language processor 230 from language model training sources 132.

The n-gram segmenter 340 may also calculate a break confidence score b(n,n+1) for each break. The break confidence score reflects the probability that a segment break occurs between two concurrent terms in the query wₙ and wₙ₊₁. For a forward sequential 3-grams analysis, a break confidence score is determined:

$${b}_{f} ( i , i + 1 ) = ( \frac{P 〈 {w}_{i} \vert {w}_{i - 2} {w}_{i - 1} 〉}{P 〈 {w}_{i + 1} \vert {w}_{i - 1} {w}_{i} 〉} )$$

For a backward sequential 3-grams analysis, a break confidence score is determined:

$${b}_{b} ( i , i + 1 ) = ( \frac{P 〈 {w}_{i + 1} \vert {w}_{i + 2} {w}_{i + 3} 〉}{P 〈 {w}_{i} \vert {w}_{i + 1} {w}_{i + 2} 〉} )$$

An overall sequential 3-grams analysis a break confidence score for each break is computed using the geometric mean of the forward and backward a break confidence scores:

b_{sequential}(i,i+1)=\sqrt{b_{f}b_{b}}

These scores are normalized to range from 0 to 1.

Break confidence score for segmentation based on single n-gram analysis are determined:

$${b}_{single} ( i , i + 1 ) = \frac{P ( {w}_{i + 1} )}{P 〈 {w}_{i + 1} \vert {w}_{i} 〉}$$

These scores are also normalized to range from 0 to 1.

The final break score b(n,n+1) for each break is a weighted geometric mean of the normalized sequential break scores and the normalized single break scores, where weights p1 and p2 are weights for each of the respective methods:

$$b ( i , i + 1 ) = {( {{[ {b}_{sequential} ( i , i + 1 ) ]}^{p 1} [ {b}_{single} ( i , i + 1 ) ]}^{p 2} )}^{\frac{1}{p 1 p 2}}$$

These scores are also normalized to range from 0 to 1.

After statistical segmentation, segments may be filtered (352) to account for language characteristics and remove terms and segments that are not considered useful. Criteria for removing, excluding, or discounting a segment may be based on tags assigned to words by part of speech tagger 328. Filtering may include:
Removing stop words from the beginning and end of each segment. Iterate until a non-stop word is encountered. Stop words in the middle of a segment are not removed, e.g., “Queen of England” stays intact.
Removing segments ending with a VBG (gerund or present participle verb form), as tagged by a part of speech tagger.
Removing segments ending in a VBD (past tense verb), a VBN (past participle verb), a VBP (non 3rd person singular present verb), a VBZ (third person singular present verb), or an apostrophe-s (“'s”).
Removing segments starting with a VBD, VBP, or VBZ.
Removing segments with a word count below a minimum word count threshold or above a maximum word count threshold.
Removing segments with a phonetic length below a minimum phonetic length threshold or above a maximum phonetic length threshold.
Removing segments that are too common to be useful. For example, removing 1-, 2-, and 3-word segments whose 1-, 2-, or 3-grams are above corresponding probability thresholds.

For example, by filtering stop words, “in the New York subway” is reduced to “New York subway.” However, as contiguous phrases are inherently more reliable in phonetic searches than isolated words, stop words are not removed from within in a phrase where the stop words are bounded on both sides by non-stop words. For example, “in” and “the” are not removed from “Jack in the Box.”

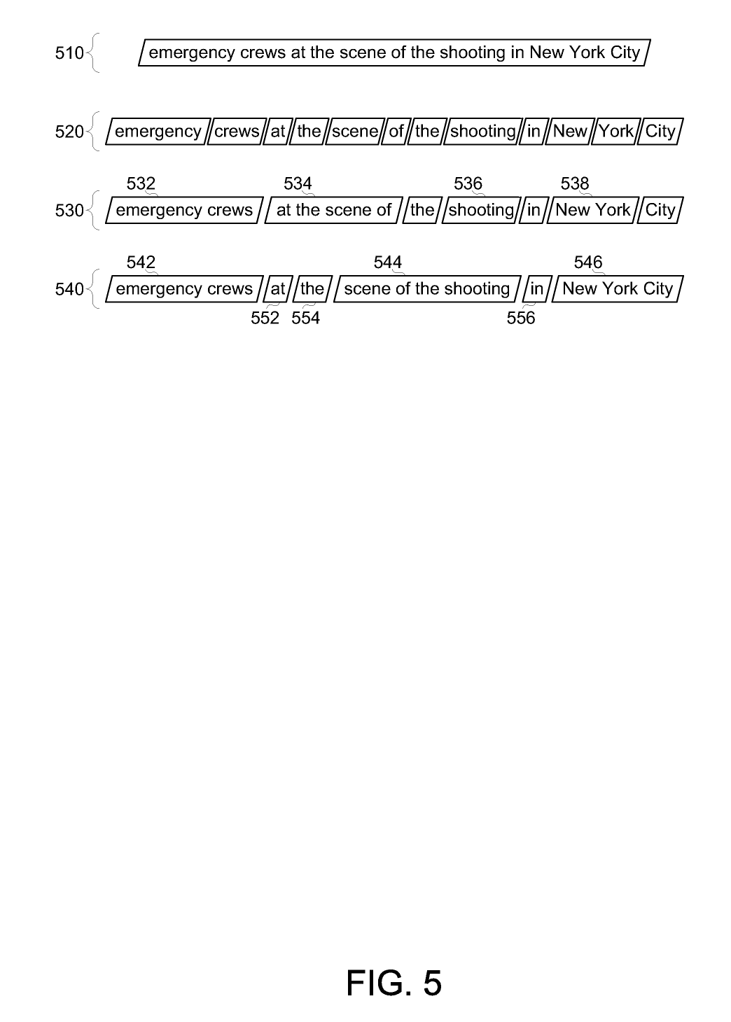

Referring to FIG. 5, a sample query 510 is processed in this manner. The query, “emergency crews at the scene of the shooting in New York City” could be divided into individual terms 520, which could then be sought in a media file. However, some of the terms can be joined into phrases 530. For example the terms “emergency” and “crews” form the common phrase “emergency crews” 532. The phrase “at the scene of” 534 might less desirable, as it is predominantly made up of stop words and there is a suitable alternative using “shooting” 536. Note that multi-word place names like “New York” 538 can also be joined as a single segment. An alternative segmentation 540 demonstrates the use of common phrases (e.g., “emergency crews” 542), phrases with internal common words (e.g., “scene of the shooting” 544), and place names (e.g., “New York City” 546). Unused stop words (e.g., “at” 552, “the” 554, and “in” 556) are less useful segments and may be dropped from the resulting segmented query.

In some implementations, phrases may be selected to be removed or to be weighted less than other phrases. Reasons for doing this are to avoid searching for very short phrases that are not meaningful (e.g. “another”) or are not good phonetic choices (e.g. “Joe”).

Referring again to FIG. 2, the word spotting engine 260 searches for each resulting query segment 226. In a first approach, the individual terms constituting a segment are individually searched and the results are combined. This approach locates phrases similar to the segment. In a second approach, the segment is searched as a whole. This approach locates positions in the media likely to match the segment as a whole, compensating for potential noise interfering with component terms.

Where a media is associated with a text (e.g., a transcript), the text can be processed into segments and the media can be pre-search for those segments. An index of the results is used to assist with searching the media. For example, these terms can be used along with phonemes in an index for a two stage search. This does not preclude also using audio terms identified in a supplied query.

Embodiments of the approaches described above may be implemented in software. For example, a computer executing a software-implemented embodiment may process data representing the unknown audio according to a query entered by the user. For example, the data representing the unknown speech may represented recordings or multiple telephone exchanges, for example, in a telephone call center between agents and customers. In some examples, the data produced by the approach represents the portions of audio that include the query entered by the user. In some examples, this data is presented to the user, for example, as a graphical or text identification of those portions. The software may be stored on a computer-readable medium, such as a disk, and executed on a general purpose or a special purpose computer, and may include instructions, such as machine instructions or high-level programming language statements according to which the computer is controlled.

It is to be understood that the foregoing description is intended to illustrate and not to limit the scope of the invention, which is defined by the scope of the appended claims. Other embodiments are within the scope of the following claims.

What is claimed is:

1. A computer-implemented method of searching a media file, the method comprising:
accepting a query comprising a sequence of terms;
identifying a set of one or more segments in the query comprising a sequence of two or more terms; and
searching the media for the occurrences of a segment in the set of segments.

2. The method of claim 1, wherein the segment comprises a subsequence of the sequence of terms.

3. The method of claim 2, wherein the segment comprises all of the terms in the query.

4. The method of claim 1, wherein accepting a query comprises receiving a sequence of terms in a text representation.

5. The method of claim 1, wherein searching the media includes:
forming a phonetic representation of each segment in the set of segments;
evaluating a score at successive times in the media representative of a certainty that the media matches the phonetic representation of each segment at the successive times; and
identifying putative occurrences of the segments according to the evaluated scores.

6. The method of claim 1, further comprising:
forming a query score according to scores associated with each of the segments in the set of segments of the query.
